(19) United States
(12) Patent Application Publication
(10) Pub. No.: US 2009/0052079 A1
(43) Pub. Date: Feb. 26, 2009

(54) Magnetic head slider fabrication method, preamplifier and magnetic disk drive

(75) Inventor: Shinichi Iwasa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/895,323

(22) Filed: Aug. 23, 2007

(30) Foreign Application Priority Data
Aug. 23, 2007 (JP) 2006-226454

(51) Int. Cl. G11B 5/02; H01F 7/06

(52) U.S. Cl. 360/67; 29/602.1

(57) ABSTRACT

Embodiments of the present invention set the resistance value and resistance change of a magnetoresistive element as the comparison criteria of a tester without use of an actual magnetic head slider in an inspection process during fabrication of magnetic head sliders. According to one embodiment, at the time of default setting of a tester, an emulator is connected to a preamplifier of a magnetic characteristic measurement device. Signals which are obtained by emulating the resistance value and resistance change of the magnetoresistive element are inputted to the preamplifier from the emulator. The resistance value and resistance change serve as references. The output of the preamplifier is A/D converted to be inputted to the MPU. In the MPU, the A/D converted output is converted into a resistance value to be stored in the ROM. The tester uses the resistance value stored in the ROM as a reference to compare the measured resistance value of the magnetoresistive element therewith. Since the set reference value changes with time, the emulator is connected to the tester regularly for checking and adjusting the reference value.

### CROSS-REFERENCE TO RELATED APPLICATION

The instant nonprovisional patent application claims priority to Japanese Patent Application No. 2006-226454, filed Aug. 23, 2006 and which is incorporated by reference in its entirety herein for all purposes.

### BACKGROUND OF THE INVENTION

A magnetic disk drive (HDD) includes a magnetic disk for retaining data and a magnetic head slider having a head element section which reads and writes data from and to the magnetic disk. The head element section includes a write element and a read element. The write element converts electric signals to magnetic fields in response to data to be written to the magnetic disk. The read element converts the magnetic fields from the magnetic disk to electric signals.

The read element uses a magnetoresistive element represented by a GMR element and a TMR element each having a high-sensitivity characteristic. Along with an increase in recording density, the magnetoresistive element has further been miniaturized. This poses a problem with deterioration of the magnetic characteristics of a free layer and a pinned layer constituting the magnetoresistive element or of a shield layer during the fabrication stage of the magnetic head slider. To solve the problem, in the fabricating stage, a row bar or a magnetic head slider mounted with a magnetoresistive element to be measured is placed on a tester. Then, a magnetic field is applied from the outside to the magnetoresistive element for measuring magnetic characteristics thereof, thus selecting non-defective products.

Japanese Patent Publication No. 2004-022024 (”Patent document 1”) describes the following method: Output characteristics of a magnetoresistive element are continuously measured at the predescribed number of times without use of a magnetic disk while an alternating electric field is applied thereto. The measurements are compared with a preset reference value. If the measurements do not meet the reference value at the predescribed number of times, the associated magnetoresistive element is selected as a defective. In addition, Patent document 1 describes the following. In a noise test, the reference value of a noise level is set at 40% to 50% of signal amplitude. In output fluctuation test, fluctuation within ±5% is set as a reference value.

Japanese Patent Publication No. 2000-163722 (“Patent document 2”) describes the following method of inspecting the characteristics of a magnetoresistive element: Varying magnetic fields are applied from the outside to a magnetoresistive element. A voltage change of the magnetoresistive element with respect to a magnetic field change is measured to create a differential signal. Only a high-frequency component of the differential signal is extracted to create a filtering signal. The characteristics of the magnetoresistive element are inspected based on the filtering signal. The filtering signal is a noise component containing Barkhausen noise. If a noise component is larger than a predescribed threshold, containing Barkhausen noise, the magnetoresistive element is judged to be defective.

While not described in patent documents 1 and 2, a tester which measures the magnetic characteristics of a magnetoresistive element needs some reference objects in order to maintain measurement accuracy and to obtain the same result between testers. In addition, it is necessary to monitor the tester in real time as to whether a test is being performed stably. There is a method in which an actual head gimbal assembly (HGA) or a magnetic head assembly is used as a reference object. However, since a magnetoresistive element mounted on a magnetic head slider is susceptible to static electricity (ESD), it is difficult to use the magnetoresistive element as a standard source stably for long periods. It is simply impractical to confirm the stability of a tester in real time during the measurement of a row bar or magnetic head slider mounted with a magnetoresistive element to be measured. There is another method in which instead of using the actual HGA or magnetic head slider as a reference object, a high-frequency transformer is used and a signal is applied from the outside to the transformer to form a pseudo magnetic head slider. However, this poses a problem in that the device becomes large-scale and it is difficult to accurately maintain a signal level. In addition, it is impossible to monitor a tester in real time. Since the high-frequency transformer has frequency characteristics, it is necessary to adjust them, which makes its handling cumbersome.

There is a method in which an actual magnetic head slider is used as a reference object to measure the magnetic characteristics of a magnetoresistive element. However, since the magnetoresistive element is susceptible to static electricity, it is difficult to use the magnetoresistive element as a standard source stably for long periods.

### BRIEF SUMMARY OF THE INVENTION

Embodiments in accordance with the present invention set the resistance value and resistance change of a magnetoresistive element as the comparison criteria of a tester without use of an actual magnetic head slider, in an inspection process during fabrication of magnetic head sliders. According to the particular embodiment disclosed in FIG. 1, at the time of default setting of a tester, an emulator 1 is connected to a preamplifier 514 of a magnetic characteristic measurement device 502. Signals which are obtained by emulating the resistance value and resistance change of the magnetoresistive element are inputted to the preamplifier 514 from the emulator. The resistance value and resistance change serve as references. The output of the preamplifier 514 is A/D converted to be inputted to the MPU. In the MPU, the A/D converted output is converted into a resistance value to be stored in the ROM 518. The tester uses the resistance value stored in the ROM 518 as a reference to compare the measured resistance value of the magnetoresistive element therewith. Since the set reference value changes with time, the emulator is connected to the tester regularly for checking and adjusting the reference value.

### BRIEF DESCRIPTION OF THE DRAWINGS

FIG. 1 is a configurational diagram of a tester used in an inspection process according to a first embodiment.

FIG. 2 is a block diagram of an emulator and its controller used in the inspection process according to the first embodiment.

FIG. 3 is a block diagram of a modification of the emulator shown in FIG. 2.

FIGS. 4(a) and 4(b) illustrate the pseudo resistance value and pseudo resistance change of the emulator.

FIG. 5 is a flowchart of a process for adjusting the gain of the tester by use of the emulator.

FIG. 6 is a process chart of a magnetic head slider fabrication method according to the first embodiment.

FIG. 7 is a block diagram of a preamplifier according to a second embodiment.

FIG. 8 illustrates the configurations of a wafer, a row bar and a thin film magnetic head.

FIG. 9 is a perspective view of a magnetic head slider as viewed from the air-bearing surface thereof.

FIG. 10 is a illustration of a layer structure of a CIP type GMR element.

FIG. 11 is a block diagram of a magnetic disk drive according to a third embodiment.

### DETAILED DESCRIPTION OF THE INVENTION

Embodiments in accordance with the present invention relate generally to a magnetic head slider fabrication method, a preamplifier and a magnetic disk drive. In particular, embodiments of the present invention relate to an emulator for a magnetoresistive element used when a magnetic characteristic test of the magnetoresistive element is performed.

It is an object of embodiments in accordance with the present invention to set the resistance value and resistance change of a magnetoresistive element as the comparison criteria of a tester without use of an actual magnetic head slider in an inspection process during fabrication of magnetic head sliders. Another object of embodiments of the present invention is to maintain the measurement accuracy of a tester by adjusting an initialization resistance value on the basis of the output of an emulator. Further, another object of the embodiments of the present invention is to provide a preamplifier which emulates the resistance value and resistance change of a magnetoresistive element. Still another object of embodiments of the present the invention is to provide a magnetic disk drive which can check quality of a magnetoresistive element by mounting thereon a preamplifier which emulates the resistance value and resistance change of a magnetoresistive element.

A magnetic head slider fabrication method according to embodiments of the present invention is such that, in the inspection step of a magnetic head slider cut out from a row bar, a magnetic field is applied to the magnetic head slider, and a resistance value and a resistance change obtained from an output signal from the magnetoresistive element mounted on a magnetic head slider are compared with a resistance signal and a resistance change obtained from an output signal of an emulator which is composed of passive elements and emulates a resistance value and a resistance change of a magnetoresistive element serving as a sample, whereby the magnetic head slider is judged to be acceptable or not.

The emulator includes, between two terminals, a main resistor, one or more sub resistors connected in series to the main resistor, and a compensation resistor, a switch and a variable resistor connected in parallel to the sub resistor, and voltage which emulates the resistance value and resistance change of the magnetoresistive element serving as a sample is produced between the two terminals by allowing sense current to flow between the two terminals, on/off controlling the switch and changing the variable resistor.

A preamplifier according to embodiments of the present invention includes a read amplifier which receives an output signal of a magnetoresistive element for amplification; and an emulator which is composed of passive elements and emulates a resistance value and a resistance change of a magnetoresistive element serving as a sample; wherein an output signal of the emulator is inputted to the read amplifier.

A magnetic disk drive according to embodiments of the present invention includes a magnetic disk; a thin film magnetic head including a read head having a magnetoresistive element and a write head and reading and writing data from and to the magnetic disk; a preamplifier including a read amplifier for amplifying a read signal from the thin film magnetic head and a write amplifier for amplifying a write signal supplied to the thin film magnetic head; a read/write channel for decoding a read signal from the preamplifier and coding data from a higher-level device into a write signal supplied to the preamplifier; and a controller; wherein the preamplifier further includes an emulator which is composed of passive elements and emulates a resistance value and a resistance change of a magnetoresistive element serving as a sample, an output signal of the emulator being inputted to the read amplifier.

The magnetic head slider fabrication method according to embodiments of the present invention can set, in the inspection step, the resistance value and resistance change of a magnetoresistive element serving as criteria for a tester without use of an actual magnetic head slider. The measurement accuracy of the tester can be maintained for a stable test by using the emulator to adjust the set reference value. The stability of the tester can be confirmed in real time during the test of the magnetoresistive element to be measured. The preamplifier according to embodiments of the present invention can emulate the resistance value and resistance change of the magnetoresistive element. The magnetic disk drive according to embodiments of the present invention is mounted with a preamplifier incorporating an emulator which emulates the resistance value and resistance change of the magnetoresistive element. Therefore, the magnetic disk drive alone can check the quality of a magnetoresistive element.

Embodiments of the present invention will hereinafter be described with reference to the drawings. Note that like reference numerals denote like or corresponding elements in the figures and duplicated explanation is omitted to clarify the description.

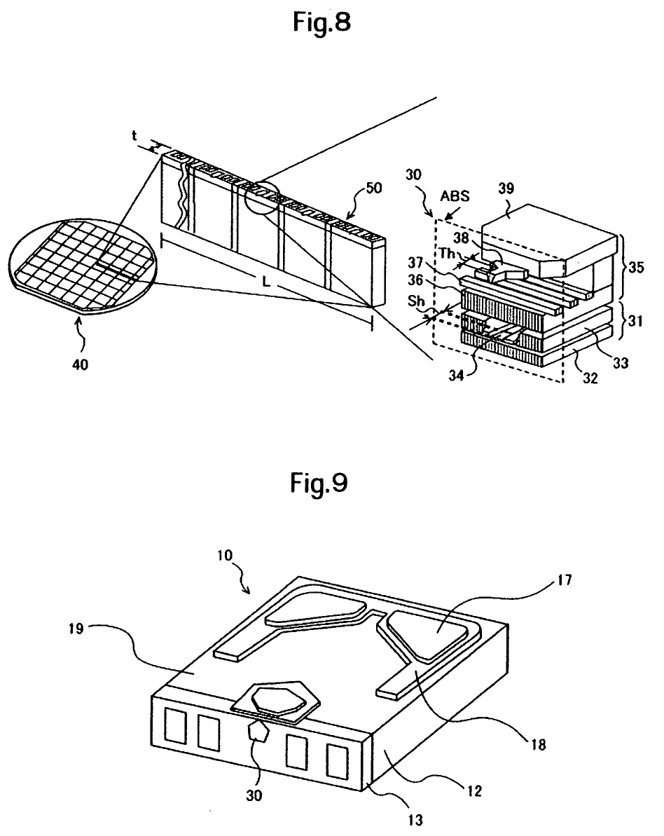

Configurations of a thin film magnetic head and a magnetic head slider pertaining to embodiments of the present invention are described with reference to FIGS. 8 and 9. FIG. 8 is an illustration of a schematic configuration of a wafer 40, a row bar 50 cut out from the wafer and a thin film magnetic head 30 on the row bar. FIG. 9 is an illustration of a configuration of a magnetic head slider 10 obtained by cutting the row bar 50. Referring to FIG. 8, the thin film magnetic head 30 includes a write head 35 and a read head 31. The write head 35 is a head which generates a magnetic field used to write date on a recording layer of a magnetic disk not shown. The write head 35 includes a lower magnetic core 36, an upper magnetic pole piece 38, an upper magnetic core 39 and a thin film coil 37 which is interlinked with a magnetic circuit formed by the lower and upper magnetic cores. The read head 31 is a head for reading data written on the magnetic disk and includes a read element 34 such as a GMR element, a TMR element or the like put between a pair of upper and lower magnetic shields 32,33.

Referring to FIG. 9, the magnetic head slider 10 includes a slider 12 and a head element section 13 which is provided with a thin film magnetic head 30. An air-bearing surface rails 17, lower rails 18 and a lower surface 19 are formed on an air-bearing surface of the magnetic head slider 10 confronting the magnetic disk.

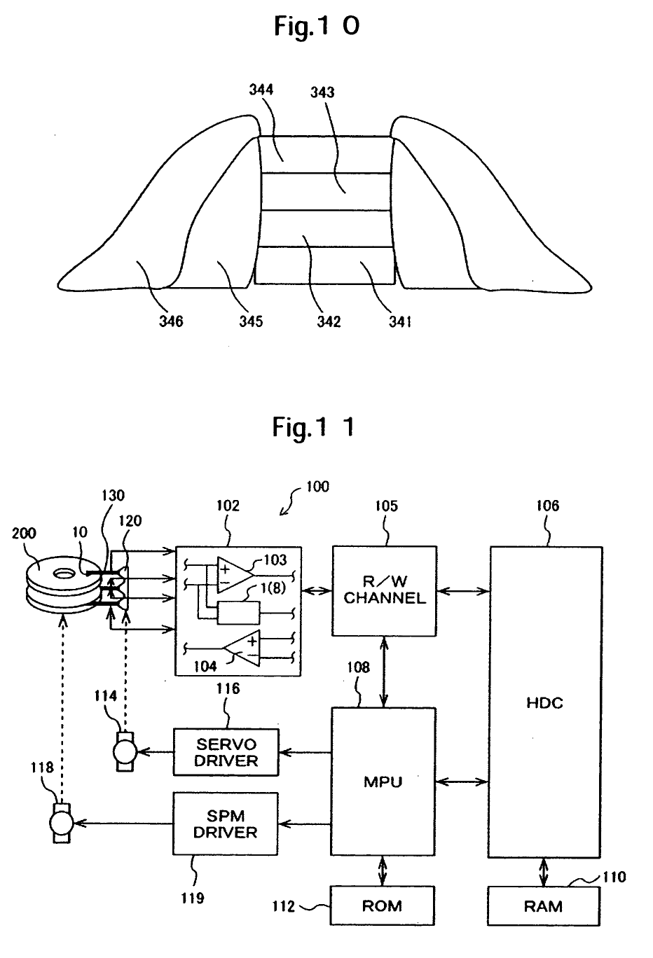

FIG. 10 is an enlarged view of the read element 34 as viewed from the air bearing surface side, illustrating the layer structure of a CIP (Current In the Plane) GMR element. In the figure, reference numeral 341 denotes an antiferromagnetic layer, 342 and 344 denote two ferromagnetic layers magnetically separated by a nonmagnetic conductive layer 343. Hard bias 345 and an electrode 346 are disposed on both sides of the ferromagnetic layers. The magnetization-orientation of the ferromagnetic layer (the pinned layer) 342 is pinned by an exchange coupling magnetic field occurring on an interface with the antiferromagnetic layer 341. In contrast to this, the magnetization-orientation of the ferromagnetic layer (the free layer) 344 is variable in response to the orientation of the external magnetic field. The magnetic disk drive reads data on the magnetic disk by using characteristics in which the resistance of the GMR element 34 is changed depending on an angle formed between the pinned layer 342 and the free layer 344. More specifically, when the magnetization-orientation of the pinned layer 342 is parallel to the magnetization-orientation of the free layer 344, the resistance of the GMR element is minimized. When the magnetization-orientation of the pinned layer 342 is antiparallel to the magnetization-orientation of the free layer 344, the resistance of the GMR element is maximized. Incidentally, when the read element 34 is a CPP (Current Perpendicular to the Plane) GMR element or a TMR element, an insulating layer is disposed between the pinned layer 342 and the free layer 344 and electrodes are provided on and under the laminated body.

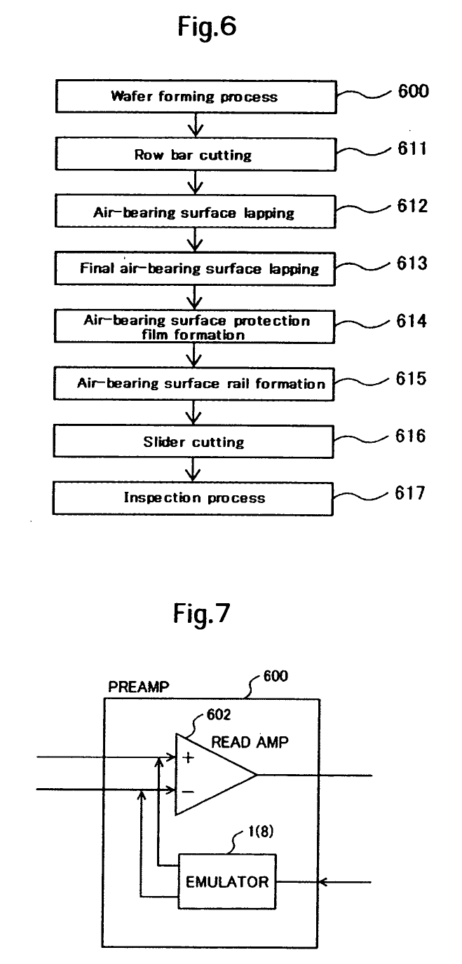

With reference to FIG. 6, a description is next made of a magnetic head slider fabrication method according to a first embodiment of the present invention. Refer additionally to FIGS. 8 to 10.

Step 600: In a wafer formation process, a plurality of head elements including the read head 5 and the write head 9 are formed on the wafer 40 by thin film processes such as sputtering, plating, ion milling, photolithography, etc.

Step 611: In a row bar cutting process, the wafer 40 is cut into row bars 50 by slicing using a diamond cutting whetstone as a tool. The row bar 50 is composed of about fifty head elements joined together and has a length L of about 50 mm and a thickness t of about 0.3 mm.

Step 612: An air-bearing surface lapping process is a process for controlling the throat height Th of the write head 9 and the sensor height Sh of the read head 5. In this process, the lapping surface (the air-bearing surface) of the row bar 50 is pressed against and lapped by the rotating lapping surface table while being swung in the radial direction of the table.

Step 613: In a final air-bearing surface lapping process, the air-bearing surface is lapped to improve the surface roughness of the air-bearing surface and reduce differences in step in the process.

Step 614: In an air-bearing surface protection film forming process, a protection film having a thickness of 3 to 6 nm is formed to protect the read head 5 and write head 9 both exposed to the air-bearing surface. The protection film is formed with a Si film as a contact layer and with a diamond-like carbon thereon.

Step 615: In an air-bearing surface rail forming process, the air-bearing surface rails 17, lower rails 18 and lower surface 19 are formed on the air-bearing surface by dry processing such as ion milling, RIE or the like. Specifically, the row bar 50 is fixed to a rail formation jig using a thermoplastic adhesion tape. Resist is applied to the front face of the air-bearing surface. After exposure and development, portions other than the rails are removed by the dry processing mentioned above. Thereafter, the resist left on the air-bearing surface is peeled off. The process from the resist application to resist peeling is repeated two times to thereby form the two-stepped-shaped air-bearing surface having the air-bearing surface rails 17, lower rails 18 and lower surface 19 as shown in FIG. 9.

Step 616: In a slider cutting process, the row bar 50 is cut into head elements and separated into individual magnetic head sliders 1 by slicing using the diamond cutting whetstone as a tool.

Step 617: In an inspection process, after the separated magnetic head sliders 10 are obtained, the read elements 34 are subjected to magnetic property measurement, the sliders 2 are subjected to an external appearance check and non-defective products are selected.

In the particular embodiment of the fabrication method described above, the inspection process is applied to the magnetic head sliders. However, the present invention is not limited to this, and in other embodiments the inspection process may be applied to the row bar cut out from the wafer.

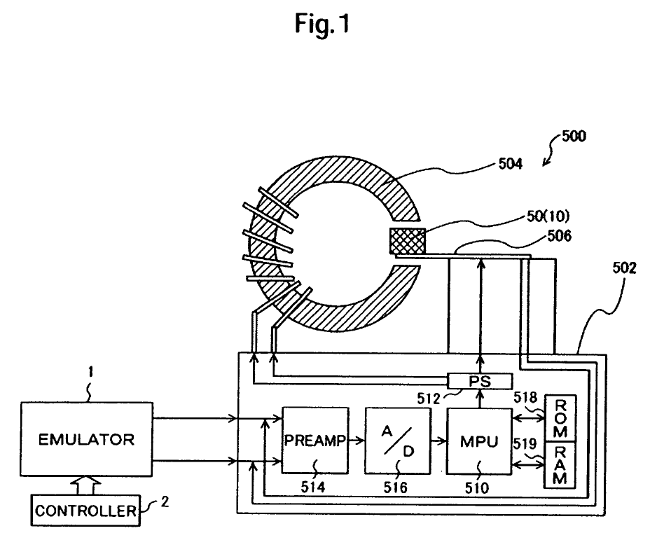

The inspection process of the magnetic head slider fabrication method is next described in detail with reference to FIG. 1. FIG. 1 depicts a conceptual diagram of a tester. The tester 500 includes a magnetic characteristic measurement device 502; a magnetic field application mechanism 504 which applies a magnetic field; and a holding mechanism 506. The hold mechanism 506 mounts the row bar 50 or magnetic head slider 10 thereon and exposes it to the magnetic field generated by the magnetic field application mechanism 504. The magnetic characteristic measurement device 502 includes a microprocessor (MPU) 510 and a current supply circuit (PS) 512 and controls the MPU 510 to energize the coil of the magnetic field application device 504 for supplying sense current to the read element 34. The read output of the read element 34 is inputted to the MPU 510, which evaluates magnetic characteristics. The magnetic characteristic measurement device 502 further includes a preamplifier 514, an analog-digital converter (A/D) 516, a ROM 518 and a RAM 519. The sense current is supplied to the read element 34 through the wiring of the holding mechanism 506. Similarly, a read signal from the read element 34 is supplied to the preamplifier 514 through the wiring of the holding mechanism 506. The main evaluation items of the tester 500 include the resistance value and resistance change of a magnetoresistive element which is the read element.

At the time of default setting of the tester 500, an emulator 1 (detailed later) is connected to the preamplifier 514 of the magnetic characteristic measurement device 502. In addition, signals (voltage signals) which are obtained by emulating the resistance value and resistance change of the read element (the magnetoresistive element) are inputted to the preamplifier 514. The resistance value and resistance change serve as references. The emulator 1 is controlled by the controller 2. The output of the preamplifier is A/D converted and the A/D converted output is inputted to the MPU 510. In the MPU, the A/D converted output is converted into a resistance value, which is stored in the ROM 518. The tester 500 uses the resistance value stored in the ROM 518 as a reference value to compare the measured resistance value of the magnetoresistive element therewith. Thus, the tester 500 evaluates whether the thin film magnetic head is a non-defective or defective product. Since the set reference value changes with time, it is necessary to check and adjust the set reference value regularly. Thus, the emulator 1 is connected to the tester 500 for checking and adjusting the reference value.

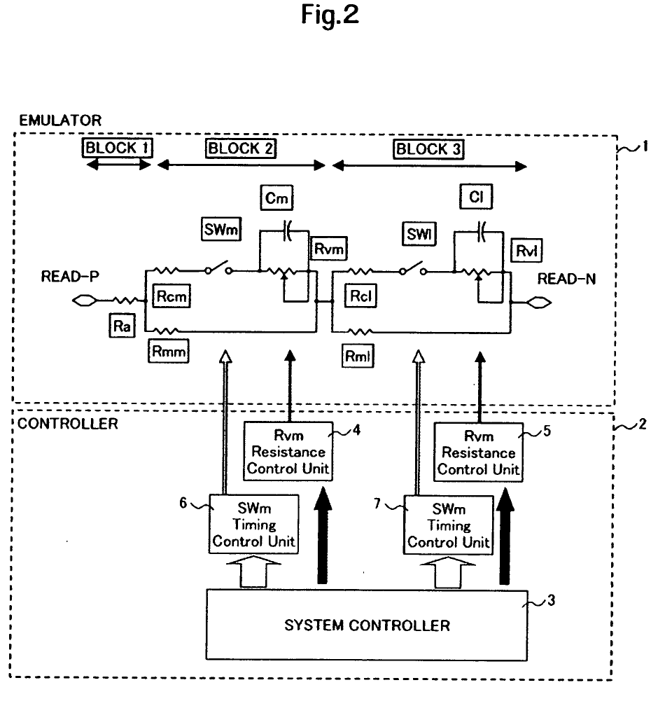

A description is next made of the configurations of the emulator and controller with reference to FIG. 2. The emulator 1 is configured by combining passive elements such as resistors. The emulator 1 can emulate the resistance value of the magnetoresistive element by changing the element characteristics (resistance value) of the passive elements in real time. The magnetoresistive element has characteristics which changes the resistance value thereof depending on a strong or weak external magnetic field. To emulate the resistance change, the emulator 1 is configured by combining block 1, block 2, and block 3 each composed of resistors with low input capacity high-frequency switches SWm, SW1. The controller 2 includes resistance control units 4 and 5 which control changes of resistance values of blocks 2 and 3, respectively, of the emulator 1; timing control units 6 and 7 which control timings of switches SWm and SW1, respectively; and a system controller 3 which controls the control units. The system controller 3 is a programmably operated control device, which issues commands to the resistance control units 4, 5 and the timing control units 6, 7.

Blocks 1, 2 and 3 of the emulator 1 is connected in series between a terminal READ-P and a terminal READ-N. Block 1 is composed of a main resistor Ra. Block 2 is composed of a base resistor (sub-base resistor) Rmm, a compensation resistor Rcm and a variable resistor Rvm. The compensation resistor Rcm and variable resistor Rvm are connected to the base resistor Rmm in parallel and connected to each other via a switch SWm. A speedup condenser Cm is connected to the variable resistor Rvm in parallel but may be omitted. The resistance value of the variable resistor Rvm is varied by the resistance control unit 4 that is operated by the command issued from the system controller 3. The switch SWm is controlled by the timing control unit 6 that is operated by the command issued from the system controller 3.

Block 3 is composed of a base resistor (sub-base resistor) Rml, a compensation resistor Rcl and a variable resistor Rvl. The compensation resistor Rcl and variable resistor Rvl are connected to the base resistor Rml in parallel and connected to each other via a switch SW1. A speedup condenser Cl is connected to the variable resistor Rvl in parallel but may be omitted. The resistance value of the variable resistor Rvl is varied by the resistance control unit 5. The control unit 5 is operated by the command issued from the system controller 3. The switch SW1 is controlled by the timing control unit 7 and is operated by the command issued from the system controller 3.

Sense current is allowed to flow between the output terminal (terminal) READ-P and the output terminal (terminal) READ-N to on/off control the switches SWm and SW1, thereby changing the resistance values of the variable resistances Rvm and Rvl, respectively. Thus, waveforms having various duty ratios and optional voltage values can be generated between the terminal READ-P and the terminal READ-N.

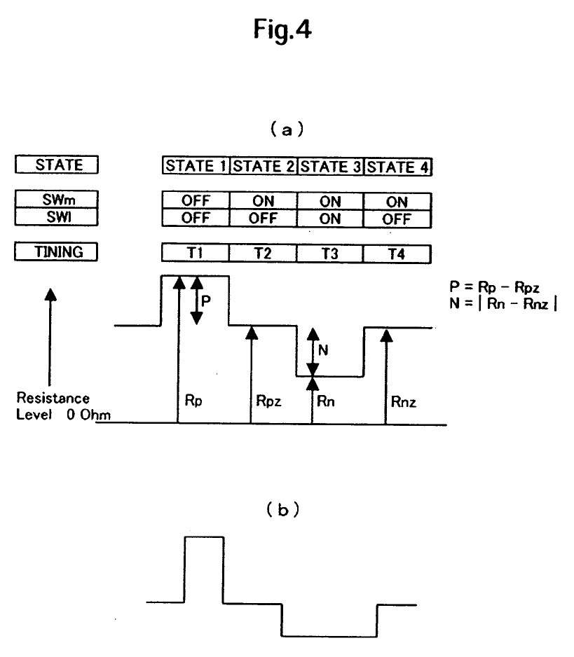

FIG. 4(a) shows the relationship between the on/off control of the switches SWm and SW1 and the duty ratio and voltage value of the voltage waveforms occurring between the terminal READ-P and the terminal READ-N. However, to make the explanation understandable, the duty ratio is made constant and the change of the resistance value is shown instead of the voltage value in FIG. 4(a). The resistance value is the actual one between the terminal READ-P and the terminal READ-N and also a resistance value obtained from sense current allowed to flow between the terminal READ-P and the terminal READ-N and from a voltage value occurring between the terminal READ-P and the terminal READ-N. State 1 indicates a case where both the switch SWm and the switch SW1 are turned off and the resistance value Rp is obtained by Ra+Rmm+Rml. State 2 indicates a case where the switch SWm and the switch SW1 are turned on and off, respectively, and the resistance value Rpz is obtained by Ra+((Rmm×(Rcm+Rvm)/Rmm+(Rcm+Rvm))+Rml. State 3 indicates a case where both the switches SWm and SW1 are turned on and the resistance value Rn is obtained by Ra+((Rmm×(Rcm+Rvm)/Rmm+(Rcm+Rvm))+((Rml×(Rcl+Rvl)/Rml+(Rcl+Rvl)). State 4 indicates a case where the switches SWm and SW1 are turned on and off, respectively, and the resistance value Rnz is equal to Rpz of state 2.

FIG. 4(a) indicates resistance-changed portions with symbols P and N. The resistance-changed portions P and N can arbitrarily be set by changing the variable resistances Rvm and Rvl in FIG. 1. In addition, the duty ratio can arbitrarily be set by controlling on/off timings T1 to T4 of the switches SWm and SW1. For example, a voltage waveform (resistance change) as shown in FIG. 4(b) can be created. Thus, the resistance value of the magnetoresistive element which serves as a sample can be emulated.

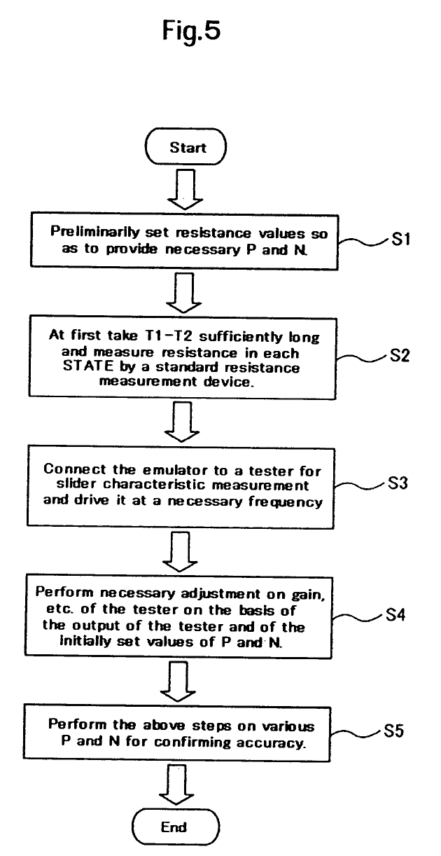

A description is made of processing for adjusting the gain and the like of the tester 500 with use of the emulator 1 with reference to FIG. 5. In step S1, the resistance values of blocks 2 and 3 are preset so as to provide the resistance changes P and N of the magnetoresistive element serving a sample. In step S2, at first the switching timings T1-T2 of the switches SWm and SW1 are made sufficiently long and the resistance between the terminal READ-P and the terminal READ-N is measured in each state by a standard resistance measurement device. In Step S3, the emulator 1 is connected to the tester 500 and driven at a necessary frequency. Next, necessary adjustment such as gain and the like is performed on the tester 500 on the basis of the output (A/D output) of the tester 500 and of the initially set values of the resistance changes P and N. In step S5, the processing steps S1 to S4 are performed on various resistance changes P and N.

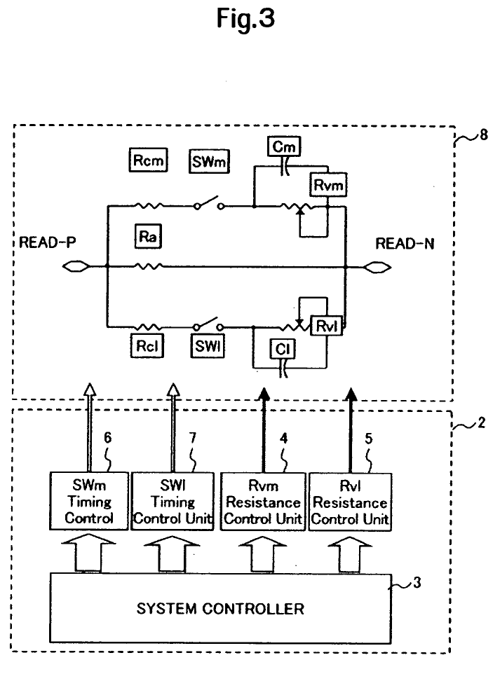

FIG. 3 illustrates a modification of the emulator shown in FIG. 2. The emulator of FIG. 3 is configured such that a compensation resistor Rcm and a variable resistor Rvm connected to each other via a switch SWm and a compensation resistor RCl and a variable resistor Rvl connected to each other via a switch SW1 are connected in parallel to a main resistor Ra. Also in this configuration, the switches SWm and SW1 are on/off controlled to change the resistance values of the variable resistors Rvm and RVl, respectively, whereby waveforms having various duty ratios and arbitrary voltage values can be generated between a terminal READ-P and a terminal READ-N.

As described above, in the inspection process of the magnetic head slider according to the first embodiment, the resistance value and resistance change of the magnetoresistive element serving as the comparison references of the tester can be set by the emulator which emulates the resistance value and resistance change of the magnetoresistive element without use of an actual magnetic head slider. The measurement accuracy of the tester can be maintained by adjusting the initially set resistance value on the basis of the output of the emulator. Therefore, a stable test can be executed. Since the emulator is a combination of passive elements, it can be made free from ESD and micro-miniaturized unlike the actual magnetoresistive element. In addition, the emulator has an advantage that frequency characteristics can be handled from DC.

A second embodiment is next described with reference to FIG. 7. In the second embodiment, the emulator 1 or 8 described in the first embodiment is mounted in a preamplifier. The preamplifier 600 includes a read amplifier 602 and the emulator 1 or 8 connected to input terminals of the read amplifier 602. The preamplifier 600 is mounted on the tester 500 of the first embodiment. The input terminals of the read amplifier 602 receive read signals from a magnetic head slider, an object to be measured. The timing control of the switches and the change of the variable resistors in the emulator 1 or 8 are performed by the MPU 510 of the tester 500.

With the second embodiment, since the preamplifier incorporates the emulator, it is not necessary to connect the emulator to the tester each time at the time of initial setting of reference resistance values or of regular check and adjustment. Thus, handling is facilitated. In addition, the stability of the tester can be confirmed in real time during the test of the magnetic head slider mounted with a magnetoresistive element to be measured.

A third embodiment is next described with reference to FIG. 11. In the third embodiment, the emulator 1 or 8 described in the first embodiment is mounted on a preamplifier of a magnetic disk drive (HDD). The basic configuration of the HDD is first described. FIG. 11 is a block diagram including the control section of the HDD 100. Disks 200 are rotated by a spindle motor 118. Magnetic head sliders 10 are each disposed to be associated with one surface of each disk 200. Each magnetic head slider 10 is attached to gimbals at the tip of a suspension 202 extending from an actuator 120 to each disk 200. The actuator 200 includes a voice coil actuator 114 which drives the suspension 202 to change the position of the magnetic head slider 10 for reading or writing data from or to a specific position(s) on one or more disks 200.

The preamplifier 102 includes a read amplifier 122 which amplifies a signal picked up by the magnetic head slider 10 and sends to a read/write channel (R/W channel) 104 the signal amplified during read operation. In addition, the preamplifier 102 includes a write amplifier 124 which sends a coded write data signal from the R/W channel 104 to the magnetic head slider 10 during write operation. The preamplifier 102 further includes the emulator 1 or 8 described in the first embodiment. The pseudo signal of the emulator 1 or 8 is inputted to the read amplifier 120. The switch timing control and the resistance change of variable resistors in the emulator 1 or 8 are controlled by a control unit (MPU) 108 via the R/W channel 104.

In read operation, the R/W channel 104 detects a data pulse from the read signal sent from the preamplifier 102 and decodes the data pulse. Then the R/W channel 104 sends the decoded data pulse to a hard disk control circuit (HDC) 106. The R/W channel 104 receives write data from the HDC 106 to code them and sends the coded write signal to the preamplifier 102.

The HDC 106 sends to the R/W channel 104 data received from a host computer (host) not shown and transfers data read from the disk 200 to the host. The HDC 106 also intermediates between the host and the MPU 108. A RAM 110 temporarily stores data transferred between the HDC 220 and, the host, the MPU 108 and the R/W channel 104. The MPU 108 controls track seeking and track following functions in response to a command from the host. A ROM 112 stores a control program from the MPU 108 and various setting values. A servo driver 116 produces drive current for the drive actuator 120 in response to a control signal which is produced by the MPU 108 to control the position of the magnetic head slider 10. The drive current is applied to the voice coil of the actuator 120. The actuator 120 positions the magnetic head slider 10 relative to the disk 200 according to the direction and quantity of the drive current supplied from the servo driver 116. A spindle motor driver 119 drives the spindle motor 118, which rotates the disk 200 according to a control value which is produced by the MPU 108 to control the disk 200.

In the above HDD, when detecting level-lowering of a read signal or a deterioration in error rate, the MPU 108 inputs the pseudo signals of the emulator 1 or 8 to the read amplifier 122 and compares them with the resistance value and resistance change of the magnetoresistive element 34 of a thin film magnetic head 30 to be mounted for checking the quality of the magnetoresistive element 34. If the MPU 108 decides that the magnetoresistive element 34 deteriorates, it issues a warning to the user.

With the third embodiment, since mounting the preamplifier incorporating the emulator which emulates the resistance value and resistance change of the magnetoresistive element, the magnetic disk drive alone can check the quality of the magnetoresistive element.

What is claimed is:

1. A magnetic head slider fabrication method comprising the steps of:
forming a read head having a magnetoresistive element and a write head on a wafer;
cutting the wafer into row bars;
lapping an air-bearing surface of each of the row bars;
forming rails on the lapped air-bearing surface;
cutting the row bar into individual magnetic head sliders; and
applying a magnetic field to each of the magnetic head sliders and inspecting a magnetic characteristic of the magnetoresistive element based on an output signal of the magnetoresistive element;
wherein the inspection step is a step of comparing a resistance value and a resistance change obtained from the output signal from the magnetoresistive element with a resistance value and a resistance change obtained from an output signal of an emulator which is composed of passive elements and emulates a resistance value and a resistance change of a magnetoresistive element serving as a sample.

2. The magnetic head slider fabrication method according to claim 1, wherein the emulator includes, between two terminals, a main resistor, one or more sub resistors connected in series to the main resistor, and a compensation resistor, a switch and a variable resistor connected in parallel to the sub resistor; and voltage which emulates the resistance value and resistance change of the magnetoresistive element serving as a sample is produced between the two terminals by allowing sense current to flow between the two terminals, on/off controlling the switch and changing the variable resistor.

3. The magnetic head slider fabrication method according to claim 1, wherein the emulator includes, between two terminals, a main resistor of the 1st block, and sub-base resistor of the 2nd block, and another sub-base resistor of the 3rd block, which are connected in series to the main resistor, a first compensation resistor, a first switch and a first variable resistor which are connected in parallel to the 2nd block sub-base resistor, and a second compensation resistor, a second switch and a second variable resistor which are connected in parallel to the 3rd block sub-base resistor; and voltage which emulates the resistance value and resistance change of the magnetoresistive element serving as a sample is produced between the two terminals by allowing sense current to flow between the two terminals, on/off controlling the first and second switches and changing the first and second variable resistors.

4. The magnetic head slider fabrication method according to claim 1, wherein the resistance value and the resistance change which are obtained from the output signal of the emulator as comparative criteria in the inspection step are regularly adjusted based on a resistance value and a resistance change which are newly obtained from the output signal of the emulator.

5. The magnetic head slider fabrication method according to claim 1, wherein the step of inspecting the magnetic characteristic of the magnetoresistive element is performed, after the step of cutting the wafer into row bars, by applying a magnetic field to each of the row bars.

6. A preamplifier comprising:
a read amplifier which receives an output signal of a magnetoresistive element for amplification; and
an emulator which is composed of passive elements and emulates a resistance value and a resistance change of a magnetoresistive element serving as a sample;
wherein an output signal of the emulator is inputted to the read amplifier.

7. The preamplifier according to claim 6, wherein the emulator includes, between two output terminals, a main resistor, one or more sub resistors connected in series to the main resistor, and a compensation resistor, a switch and a variable resistor connected in parallel to the sub resistor; and voltage which emulates the resistance value and resistance change of the magnetoresistive element serving as a sample is produced between the two output terminals by allowing sense current to flow between the two output terminals, on/off controlling the switch and changing the variable resistor.

8. The preamplifier according to claim 7, wherein the on/off control of the switch and the change of the variable resistor are performed by an external signal.

9. A magnetic disk drive comprising:
a magnetic disk retaining data;
a thin film magnetic head including a read head having a magnetoresistive element and a write head and reading and writing date from and to the magnetic disk;
a preamplifier including a read amplifier for amplifying a read signal from the thin film magnetic head and a write amplifier for amplifying a write signal supplied to the thin film magnetic head;
a read/write channel for decoding a read signal from the preamplifier and coding data from a higher-level device into a write signal supplied to the preamplifier; and
a controller;
wherein the preamplifier further includes an emulator which is composed of passive elements and emulates a resistance value and a resistance change of a magnetoresistive element serving as a sample, an output signal of the emulator being inputted to the read amplifier.

10. The magnetic disk drive according to claim 9, wherein the emulator includes, between two terminals, a main resistor, one or more sub resistors connected in series to the main resistor, and a compensation resistor, a switch and a variable resistor connected in parallel to the sub resistor; and voltage which emulates the resistance value and resistance change of the magnetoresistive element serving as a sample is produced between the two terminals by allowing sense current to flow between the two terminals, on/off controlling the switch and changing the variable resistor.

11. The magnetic desk drive according to claim 10, wherein the on/off control of the switch and the change of the variable resistor in the emulator are performed by the controller.
